(19) United States
(12) Patent Application Publication
(10) Pub. No.: US 2012/0058318 A1
(43) Pub. Date: Mar. 8, 2012

(54) DUROMETER-DIFFERENTIATED, ANTI-PUNCTURE-LEAK, LIQUID-CONTAINER COATING STRUCTURE

(75) Inventors: Russell A. Monk, Salem, OR (US); Thomas S. Ohnstad, Salem, OR (US)

(73) Assignee: High Impact Technology, LLC., Tigard, OR (US)

(21) Appl. No.: 13/218,369

(22) Filed: Aug. 25, 2011

Related U.S. Application Data
(60) Provisional application No. 61/380,226, filed on Sep. 4, 2010.

(51) Int. Cl. B32B 7/02

(52) U.S. Cl. 428/212

(57) ABSTRACT

For the outside of the wall in a liquid fuel container, a self-sealing, anti-puncture-leak, plural-layer coating possessing at least a pair of layers including (a) an inner layer, (b) another layer which is outer relative to the inner layer, and (c), a different-value structural durometer respectively characterizing each of such layers.

### CROSS REFERENCE TO RELATED APPLICATION

This application claims filing-date priority to U.S. Provisional Patent Application, Ser. No. 61/380,226, filed Sep. 4, 2010, for “Durometer-Difference, Anti-Puncture-Leak, Liquid-Container Coating Structure”, the entire disclosure content in which is hereby incorporated herein by reference.

### BACKGROUND AND SUMMARY OF THE INVENTION

Elastomeric self-sealing, anti-leak protective coatings applied to the outside of the walls in liquid containers, such as combustible-liquid (i.e., fuel) containers, in some cases including material-embedded, liquid-reaction, imbiber-bead structure, are known.

The present invention proposes a coating which generally sits in this category of self-sealing, container-applied protective coating structures, and recognizes, as an improvement, the discovered utility of creating such a coating which is defined by different-durometer, elastomeric, self-sealing layers (two or more in number).

A range of durometer values found to be especially useful in the context of implementing and practicing the invention includes durometer values lying between about 40- and about 80-Shore A.

In the context of this invention, layers possessing, i.e., characterized by, different durometer values may be arranged in a plural-layer structure in different “orders” of increasing or decreasing durometer value, progressing in layer-sequence from the inner to the outer sides of an overall protective coating. We have found that for many, though not all, applications, a very preferable arrangement is one wherein higher durometer values are located toward the outer side of the overall coating structure which is proposed by the present invention. In certain applications, those particularly where there is a desire to have a relatively hard, protective coating layer disposed immediately against the outside surface of a liquid container, the reverse order of such values may be deemed to be the most appropriate, durometer-value order. The specific order chosen by a practicer of the present invention, of course, is freely selectable by such a person.

One manner of expressing the invention generally is that it takes the form of a plural-layer, self-sealing, anti-puncture-leak coating for the outside of the wall in a liquid fuel container possessing at least a pair of layers including (a) one self-sealing, high-elastomeric-material layer characterized structurally with one, elastomeric-material durometer value, and (b) another self-sealing, high-elastomeric-material layer disposed operatively adjacent the first layer, characterized structurally with a another, different, elastomeric-material durometer value. In this coating, one of these “at least pair of layers, in operative condition relative to a coating-protected liquid container, is an inner layer, and the other layer, an outer layer. In one version of this proposed coating structure, the structural, elastomeric-material durometer value characterizing the inner layer is lower than that characterizing the outer layer, and in another version, the reverse arrangement is the case.

Another manner generally of describing the invention is that it is a self-sealing, anti-puncture-leak, plural-layer coating for the outside of the wall in a liquid fuel container possessing (a) three, self-sealing, high-elastomeric-material layers including an inner layer, an intermediate layer, and an outer layer, and (b) a different-value structural durometer respectively characterizing each of such layers, with the structural durometer value which characterizes the inner layer being lesser than that characterizing the intermediate layer, and that characterizing said intermediate layer being lesser than that characterizing the outer layer. In certain instances, this just-expressed durometer-value order for the three layers may be reversed.

A modified form of such a three-layer organization is one in which there is embedded in the intermediate layer a distributed population lo appropriate, anti-leakage-assisting, liquid-imbiber beads.

Various other features and advantages which are offered by the self-sealing, anti-puncture-leak coating of the present invention will become more fully apparent as the detailed description of the invention which follows below is read in conjunction with the accompanying drawings.

### DESCRIPTION OF THE DRAWINGS

FIG. 1 is a simplified, fragmentary, cross-sectional view illustrating a two-layer, self-sealing, anti-leak protective coating made in accordance with one preferred and best-mode embodiment of the present invention, illustrated in a condition applied to the outside surface of the wall in a liquid-fuel container.

FIG. 2 is similar to FIG. 1, except that what is pictured in FIG. 2 is a three-layer, alternatively preferred and best-mode embodiment of the coating structure of the present invention, also shown applied to the outside surface of the wall in a liquid fuel container as in FIG. 1. In FIG. 2, the central-illustrated, or intermediate, layer is pictured including a distribution of plural, embedded, liquid-fuel imbiber beads.

### DETAILED DESCRIPTION OF THE INVENTION

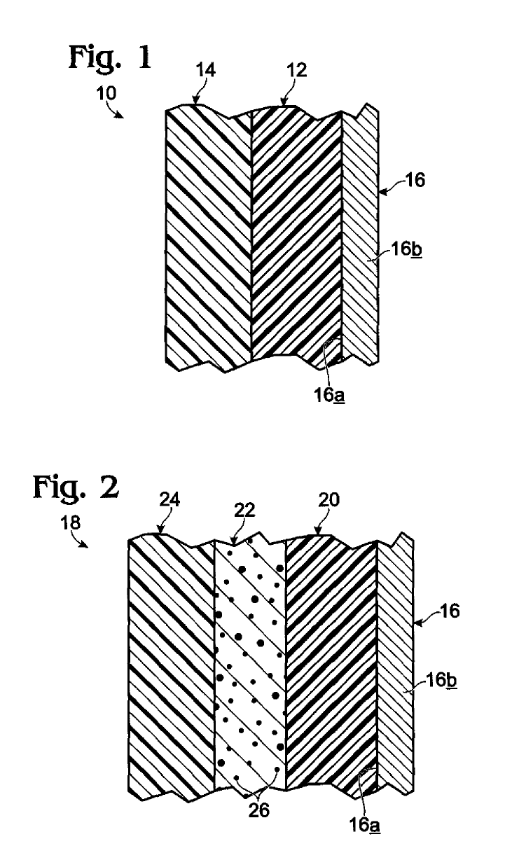

Turning attention now to the drawings, and referring first of all to FIG. 1, indicated generally at 10 is a plural-layer, self-sealing, anti-puncture-leak coating constructed in accordance with one preferred and best-mode embodiment of the invention. Coating 10, which includes inner and outer layers 12, 14, respectively, is shown in an operative condition applied, as by spraying, to the outside surface 16a of the wall 16b in a liquid petroleum fuel container 16. Such spraying, which is also used to create the coating layers that are still to be described in the relation to the alternative embodiment of the invention seen in FIG. 2, may be entirely conventional, and is not elaborated herein.

Layers 12, 14 herein are formed of a liquid-fuel-reactive, high-elastomeric, a high-tensile-strength, high-tear-resistance, material, and for this material, we have chosen, as a preferred material, the two-compound polyurethane elastomer product sold under the trademark TUFF STUFF®FR, made by Rhino Linings USA, Inc.—a company based in San Diego, Calif.

Layers 12, 14 are pictured in FIG. 1 in cross-section, marked with different-character cross-sectional indicia in order to indicate the fact, that these two layers are characterized, respectively, with different, structural, elastomeric-material durometer values. In the particular embodiment of coating 10 now being described, inner layer 12 has a structural durometer value of about 80-Shore A, and layer 14 a structural durometer value of about 40-Shore A. These durometer values are not only readily obtainable from the company mentioned above which makes the described, preferred, high-elastomeric material, they are also readily producible in like, high-elastomeric materials made by those generally skilled in the relevant, materials-processing art.

In this particular embodiment of the invention, inner layer 12 preferably has a thickness of about 0.250- to about 0.350-inches, and outer layer 14, a thickness of about 0.200- to about 0.500-inches.

Looking at FIG. 1 from a slightly different point of view, this figure may be visualized as illustrating, also, a modified form of the invention in which the respective durometer-level values associated with layers 12, 14 are reversed. In this circumstance, layer 12, would here have the higher durometer value, and would preferably still also have the same thickness just mentioned for it above. The same kinds of statements would also be true for layer 14, now with the lower durometer value, and with the same respective thickness mentioned for it above.

We have determined that the two, just-mentioned, specific durometer-level values for the high-elastomeric material to be employed in the proposed container-coating layers of the present invention define essentially the opposite ends of the range of durometer values which seems to be most appropriate for implementing the invention.

Looking now at FIG. 2 in the drawings, here there is illustrated another preferred and best-mode embodiment of the invention, with this embodiment featuring a plural-layer coating 18, which includes inner, intermediate and outer high-elastomeric, etc. layers 20, 22, 24 pictured in operative condition appropriately spray-applied to the previously mentioned outside wall surface, 16a, in liquid fuel container 16.

Each of the layers which makes up coating 18 is formed with a main body of the same high-elastomeric material discussed above in relation to coating 12. Intermediate layer 22 additionally, includes an embedded distribution of plural, conventionally available, liquid-fuel imbiber beads 26. Beads 26 herein are made of the product known as IMB230300, produced by Imbibitive Technologies America, Inc. in Midland, Mich. These beads preferably are blended, in any appropriate manner during a layer-creation spraying operation, into the entraining elastomeric material so as to constitute about 20% by weight of the combined material which makes up layer 22.

Layers 20, 22, 24 herein have, as respective, preferred thicknesses, 0.250-inches, 0.150-inches and 0.300-inches.

Looking at FIG. 2 from one point of view, the structural durometer values which characterize the inner, intermediate and outer layers, 20, 22, 24, respectively, are 40-Shore A, 60-Shore A, and 80-Shore A, respectively. Just as was described with respect to what is shown in FIG. 1, the layer arrangement shown in FIG. 2, in terms of the sequence order of durometer values, may be reversed, with inner layer 20 having a structural durometer value of 80-Shore A, intermediate layer 22 having the same, 60-Shore A structural durometer value just mentioned above for it, and outer layer 24 a structural durometer value of 40-Shore A.

There are many reasons why it may be interesting and important to provide anti-leakage self-sealing protective plural layer coatings like those just described and offered by the present invention in various liquid-fuel-container protective situations. For example, in instances where it may be desired to offer a protective coating having a noticeably high abrasion resistance, it may there be important to offer a protective coating, of either of the categories illustrated and described herein, wherein the outer, or outermost, layer is characterized with a relatively large structural durometer value, while material disposed inwardly of that layer is relatively softer. In other instances, it may be important to provide, immediately contactively adjacent the surface of a protected liquid-fuel container, a self-sealing layer which there offers the highest-level structural durometer value in a plural-layer protective coating. Other instances wherein it may be useful to offer differentiated, plural-layer durometer value coatings will certainly come to the minds of those generally skilled in the art of providing protective coatings like those which are described and illustrated herein

It should be understood that the specific durometer values which have been mentioned herein are principally illustrative of values that we have found to work very well throughout a wide range of applications. It should also be noted that while the present invention has been described principally in relation to two, different, specific, plural-layer embodiments, other embodiments are possible which may employ more than the three-layers which are pictured in, and described with respect to, the embodiment of FIG. 2.

Accordingly, preferred and best-motive embodiments of the invention, along with suggestions for certain variations and modifications, have been described and illustrated herein. As has just been expressed immediately above, we recognize that other variations and modifications may come to the minds of those generally skilled in the relevant art, and it is our intention, and expectation, that all such variations and modifications will be determined to be well within the scopes of the appended claims.

We claim:

1. A plural-layer, self-sealing, anti-puncture-leak coating for the outside of the wall in a liquid fuel container comprising at least a pair of layers including
one self-sealing, high-elastomeric-material layer characterized structurally with one, elastomeric-material durometer value, and
another self-sealing, high-elastomeric-material layer disposed operatively adjacent said first layer, characterized structurally with a another, different, elastomeric-material durometer value.

2. The coating of claim 1, wherein said one in said at least a pair of layers is structured to be an inner layer, and said other layer in the pair is structured to be an outer layer relative to said one layer, and the structural, elastomeric-material durometer value characterizing said one, inner layer is lower than that characterizing said other, outer layer.

3. The coating of claim 1, wherein said one in said at least a pair of layers is structured to be an inner layer, and said other layer in the pair is structured to be an outer layer relative to said one layer, and the structural, elastomeric-material durometer value characterizing said one, inner layer is greater than that characterizing said other, outer layer.

4. The coating of claim 1, wherein the different, structural durometer values of the layers lie in the range of about 40-Shore A to about 80-Shore A.

5. A self-sealing, anti-puncture-leak, plural-layer coating for the outside of the wall in a liquid fuel container comprising
three, self-sealing, high-elastomeric-material layers including an inner layer, an intermediate layer, and an outer layer, and
a different-value structural durometer respectively characterizing each of said layers, with the structural durometer value which characterizes said inner layer being lesser than that characterizing said intermediate layer, and that characterizing said intermediate layer being lesser than that characterizing said outer layer.

6. The coating of claim 5, wherein at least one of said layers possesses an embedded distribution of liquid-fuel imbiber beads.

7. The coating of claim 6, wherein said at least one layer is said intermediate layer.

8. A self-sealing, anti-puncture-leak, plural-layer coating for the outside of the wall in a liquid fuel container comprising
three self-sealing, high-elastomeric-material layers including an inner layer, an intermediate layer, and an outer layer, and
a different-value structural durometer respectively characterizing each of said layers, with the structural durometer value which characterizes said inner layer being greater than that characterizing said intermediate layer, and that characterizing said intermediate layer being greater than that characterizing said outer layer.

9. The coating of claim 8, wherein at least one of said layers possesses an embedded distribution of liquid-fuel imbiber beads.

10. The coating of claim 9, wherein said at least one layer is said intermediate layer.
